(19) United States
(12) Patent Application Publication
(10) Pub. No.: US 2025/0033758 A1
(43) Pub. Date: Jan. 30, 2025

(54) AIRCRAFT SURFACE STRUCTURE

(71) Applicant: Airbus Operations Limited, Bristol (GB)

(72) Inventors: David Alistair SUTTON, Bristol (GB); Colin John WEST, Bristol (GB); Guy Mortimer TOTHILL, Bristol (GB)

(21) Appl. No.: 18/591,441

(22) Filed: Feb. 29, 2024

(30) Foreign Application Priority Data
Mar. 17, 2023 (GB) 2303945.6

(51) Int. Cl. B64C 3/36

(52) U.S. Cl. CPC B64C 3/36

(57) ABSTRACT

An aircraft morphable aerodynamic surface structure including an elastomeric material having a glass transition temperature, a temperature management system for heating or cooling the elastomeric material, and a controller to control the temperature management system, the controller configured to control the temperature management system on the basis of a command received at the controller.

### RELATED APPLICATION

This application incorporates by reference and claims priority to United Kingdom patent application GB 2303945.6, filed 17 Mar. 2023.

### TECHNICAL FIELD

The present invention relates to an aircraft surface structure, specifically an aircraft morphable aerodynamic surface structure.

### BACKGROUND

It is known for aircraft to have broadly rigid unchangeable surface structures. This is in contrast to natural flying dynamics of birds, whose bodies change shape and adapt to the particular stages of their flight. Morphable aerodynamic surface structures have been theorised as a way of optimising the flight dynamics of aircraft by changing a shape of the aircraft according to need. To be practical, a morphable aerodynamic surface structure would need to be flexible to be able to change shape, resilient to withstand the harsh in-flight conditions, and capable of preserving the aerodynamic surface while changing shape.

### SUMMARY

A first aspect of the present invention provides an aircraft morphable aerodynamic surface structure, comprising: an elastomeric material having a glass transition temperature, and a controller to control a temperature management system that is for changing a temperature of the elastomeric material, the controller configured to control the temperature management system on the basis of a command received at the controller.

A capacity for controlling the shape of part of an aircraft is desirable to modify its characteristics for various functions. For example, different wing lengths may be optimal for cruising than for take-off or landing. Maintaining a continuous aerodynamic surface is desirable for reducing drag during flight and thus optimising aircraft performance. The aircraft morphable aerodynamic surface structure of the first aspect provides a way of maintaining, with fewer or no steps and gaps, a continuous aerodynamic surface across aircraft parts, for example parts of an aircraft wing, which may be subjected to a shape change during aircraft operation. Being able to change a temperature of the elastomeric material allows the elastomeric material to have the required visco-elastic properties over an entire operating temperature range of an aircraft, including when the ambient temperature would otherwise cool the elastomeric material to below the glass transition temperature.

Optionally, the aircraft morphable aerodynamic surface structure comprises the temperature management system. Accordingly, when the structure is in use in an aircraft, the temperature management system is part of the aircraft. This is convenient, since it means the temperature management system is always present and thus available for use. Alternatively, the temperature management system is separate from, or remote from, the aircraft morphable aerodynamic surface structure. For example, the temperature management system may be a remote source of heat or cooling. This may be particularly beneficial for smaller aircraft, such as unmanned aerial vehicles (UAVs, or “drones”), where it is particularly desirable to minimise the weight of the aircraft. For example, the elastomeric material could be heated with a hot air gun or other source of heat, or cooled by a refrigeration system of other source of cool air, before launch.

Optionally, the temperature management system comprises a cooling system for cooling the elastomeric material. This may be particularly beneficial in hot climates. It may be desirable to manage the temperature of the elastomeric material to improve its impact resistance, such as sand erosion or water erosion. Additionally, or alternatively, cooling the elastomeric material stiffens the elastomeric material and thus reduces flutter or other small scale deformation of the elastomeric material due to airflow, particularly in hot climates. The cooling system may comprise any suitable system for cooling the elastomeric material, such as a refrigeration system comprising refrigerant in one or more fluid flow channels that are in thermal contact with the elastomeric material.

Optionally, the temperature management system comprises a heating system for heating the elastomeric material. This could be to facilitate a shape change of the aircraft morphable aerodynamic surface structure or, for example, to improve resistance to bird strike particularly during takeoff and landing.

Elastomeric materials have a glass transition temperature around which their elasticity is reduced, and their shape change capacity is thus limited. The heating system is a way of heating the elastomeric material, for example to facilitate a shape change.

Optionally, the heating system comprises a heatable material and is configured to cause heating of the heatable material to cause heat to be transferred from the heatable material to the elastomeric material.

The heatable material may be heated and transfer heat to the elastomeric material to increase a temperature of the elastomeric material.

Optionally, the heatable material is located within the elastomeric material.

This may be advantageous for heat transfer properties, such as for example the speed at which heat may be delivered to the elastomeric material, and the evenness and/or efficiency of the heating of the elastomeric material.

Optionally, the heatable material is electrically conductive and the heating system is configured to pass an electric current through the heatable material to resistively heat the heatable material. This provides a relatively simple mechanism for heating the heatable material and, thus, the elastomeric material. In some examples, the elastomeric material is considered an electrically conductive elastomeric material, due to its chemical composition.

Optionally, the heatable material comprises particles, such as electrically conductive particles, dispersed in the elastomeric material. Optionally, the particles comprise nanoparticles. Optionally, the nanoparticles comprise carbon nanotubes. Such materials may be considered electrically conductive filler. The addition of such electrically conductive filler is known to also improve the mechanical properties of certain elastomeric materials, such as vulcanised rubber.

Carbon nanotubes may be embedded into the elastomeric material and provide an electrically conductive path through the elastomeric material. Carbon nanotubes are particularly desirable for this purpose due to their suitable electrical properties. Carbon nanotubes also have been found to have no or little detrimental effects on the mechanical properties of the elastomeric material.

Optionally, the aircraft morphable aerodynamic surface structure comprises an actuator for actuating a shape change of the aircraft morphable aerodynamic surface structure. By “actuator” it is meant any device or mover that can be actuated or operated to act on part of the structure to thereby change a shape of the structure. The actuator could be mechanical, electromechanical, pneumatic or hydraulic, for example. The actuator could be rigid or it could be compliant or flexible, such as movers or actuators used in soft robotics. Such actuators as used in soft robotics may be provided to enable small scale manipulation of a surface profile of the surface structure. An actuator facilitates the shape change of the aircraft morphable aerodynamic surface into a shape as necessary during operation of the aircraft. The actuator may be embedded inside the elastomeric material. The actuator may be located in a superimposition with the elastomeric material. The actuator may be connected to other flight control systems. The heating system is usable to soften the elastomeric material to therefore facilitate operation of the actuator to cause the shape change.

Optionally, the actuator is for actuating a shape change of the aircraft morphable aerodynamic surface structure under control of the controller. In other words, the actuator may be controlled by the same controller as the temperature management system to facilitate the operation of the aircraft morphable aerodynamic surface structure and reduce the workload of the flight crew. The controller may be operable to produce macro aerodynamic changes, such as by causing the actuator to move a flight control surface to influence the trajectory of the aircraft in use, or micro aerodynamic changes, such as operating the temperature management system to cool the elastomeric material to make it more taut and less prone to fluttering.

Optionally, the aircraft morphable aerodynamic surface structure comprises a temperature sensor for monitoring a temperature of the elastomeric material, wherein the controller is configured to control the temperature management system on the basis of an output of the temperature sensor. The temperature sensor provides information to inform the controller whether the elastomeric materials is, for example, below or at or above the glass transition temperature. The temperature sensor could be of any suitable kind, such as a thermometer, a thermal imaging camera, or a device for measuring the bulk resistivity of the elastomeric material. When the temperature sensor is a device for measuring bulk resistivity, resistivity data output by the device for measuring bulk resistivity may be used to monitor structural health characteristics of the elastomeric material over time. The temperature sensor could also determine the temperature based on one or more other inputs, such as a load experienced by the actuator when the actuator is driven to move a predetermined amount. The controller may be configured to, for example, cause the temperature management system to heat the elastomeric material if the controller determines that the temperature of the elastomeric material is below the glass transition temperature on the basis of an output of the temperature sensor and the controller has received a command to prepare for a shape change or to enter a region with a high likelihood of bird strike. Alternatively, or additionally, the controller may be configured to, for example, cause the temperature management system to cool, or manage temperature of, the elastomeric material if the controller determines that the temperature of the elastomeric material is above the glass transition temperature on the basis of an output of the temperature sensor and the controller has received a command to prepare for entry into a region with a high likelihood of sand erosion, or simply to make the surface of the aircraft more taut for aerodynamic efficiencies.

Optionally, the temperature management system is for changing a temperature of respective portions of the elastomeric material independently of each other, and the controller is configured to control the temperature management system to change the temperature of the respective portions of the elastomeric material independently of each other. Independently thermally controllable portions of the elastomeric material permit the optimisation of the temperature management such that, for example, only the parts which require shape change are heated so that the remaining parts may remain rigid and so less vulnerable to the in-flight conditions.

A second aspect of the present invention provides a method of controlling an aircraft morphable aerodynamic surface structure comprising an elastomeric material having a glass transition temperature, the method comprising: receiving a command; and on the basis of the command, controlling a temperature management system, wherein the temperature management system is for changing a temperature of the elastomeric material.

Optionally, the temperature management system is part of the aircraft morphable aerodynamic surface structure. Alternatively, the temperature management system may be separate from, or remote from, the aircraft morphable aerodynamic surface structure.

Optionally, the temperature management system comprises: a heating system for heating the elastomeric material, and/or a cooling system for cooling the elastomeric material.

Optionally, the controlling the temperature management system comprises controlling the heating system to heat the elastomeric material above an ambient temperature of the elastomeric material.

Optionally, the controlling the temperature management system comprises controlling the heating system to heat the elastomeric material to a temperature below the glass transition temperature. In cooler environments, the heating may be performed to bring the temperature of the elastomeric material above ambient temperature but not above the glass transition temperature in order to, for example, permit subsequent heating of the elastomeric material above its glass transition temperature to be achieved more quickly when required.

Optionally, the controlling the temperature management system comprises controlling the heating system to heat the elastomeric material to, or to a temperature above, the glass transition temperature. Again, particularly in cooler climates, the method may beneficially be used to heat the elastomeric material above its glass transition temperature when shape change is desirable or, for example, to improve protection against bird strike, particularly during takeoff or landing.

Optionally, the controlling the temperature management system comprises controlling the heating system to not heat the elastomeric material. Not heating the elastomeric material, when shape change is not required, allows the elastomeric material to be cooled to ambient temperature, which for most elastomeric materials will be below the glass transition temperature at cruising altitude. This permits the elastomeric material to advantageously gain rigidity when not required to morph. This may help to prevent erosion, fluttering or other small-scale deformation of the elastomeric material, and other damaging or undesirable occurrences from taking place. In other scenarios, such as when the aircraft is in a hot environment, the ambient temperature, and thus the temperature of the elastomeric material, may already be above the glass transition temperature. In such scenarios, the controlling may again comprise controlling the temperature management system to not heat the elastomeric material.

Optionally, the controlling the temperature management system comprises controlling a cooling system of the temperature management system to cool the elastomeric material. This could be for one of the reasons mentioned above, for example.

Optionally, the method comprises monitoring a temperature of the elastomeric material, and the controlling the temperature management system is on the basis of the monitoring.

Optionally, the method comprises determining whether to control the temperature management system, and the controlling the temperature management system is on the basis of the determining.

The monitoring will inform the controller if the elastomeric material is below, at, or above its glass transition temperature. The controller may make a determination as to whether and how to operate the temperature management system depending on one or more of conditions such as: whether the temperature of the elastomeric material is above or below the glass transition temperature; whether or not a shape change is desired; whether the temperature of the elastomeric material is to be kept at an above-ambient temperature, for example, in anticipation of a shape change; and whether the elastomer is to be kept rigid, for example, in anticipation of entering a sand storm.

Optionally, the method comprises determining a current ambient temperature, and the controlling the temperature management system is on the basis of the current ambient temperature. For example, the controller may be configured to cause the temperature management system to heat the elastomeric material when the current ambient temperature is below a predetermined threshold temperature. Additionally, or alternatively, the controller may be configured to cause the temperature management system to cool, or to not heat, the elastomeric material when the current ambient temperature is at or above a predetermined threshold temperature. Accordingly, the temperature management system could be considered to be automatically controlled during the flight, i.e., without requiring human intervention.

Optionally, the method comprises determining expected future ambient temperatures during a flight, and the controlling the temperature management system is during the flight and on the basis of the expected future ambient temperatures. For example, the controller may be configured to cause the temperature management system to heat and/or to cool and/or to not heat or cool the elastomeric material during different phases of the flight and in anticipation of the aircraft entering particular geographical areas, to better ensure that the elastomeric material is at preferred or predetermined temperatures when subsequently in those geographical areas. Again, the temperature management system could be considered to be automatically controlled during the flight, i.e., without requiring human intervention.

Optionally, the controller is configured to “learn” specific characteristics of the aircraft morphable aerodynamic surface structure over time. This may be by way of one or more feedback loops that enable the controller to determine what control of the temperature management system (or of the actuator(s), when present) is required to achieve a particular aerodynamic effect or other outcome. The feedback loop(s) may, for example, inform the controller of the temperature of the elastomeric material, the position of the actuator(s) (when present), and/or an air pressure at a surface of the aircraft morphable aerodynamic surface structure, for given commands given to the temperature management system (or to the actuator(s), when present) in given circumstances (such as ambient temperature). This information informed to the controller may be stored in a memory accessible by the controller. The controller may be configured to then consult the information, and to control the temperature management system (or of the actuator(s), when present) on the basis of the information. This could lead to improved performance, such as quicker or more accurate achievement of a desired aerodynamic effect or other outcome.

Optionally, the temperature management system is for changing a temperature of respective portions of the elastomeric material independently of each other, and the controlling the temperature management system comprises controlling the temperature management system to change the temperature of only one or a subset of the respective portions of the elastomeric material.

Heating or cooling of respective portions of the elastomeric material independently in this way allows optimisation of the properties of each respective portion at any point during operation. For example, certain portions may require changes to their shape frequently and are best kept at just below the glass transition temperature in order to be ready to be heated above the glass transition temperature rapidly. Other portions may only require shape change infrequently, such as just before, after or during take-off and landing, and thus may remain unheated to retain rigidity at cruising altitude and only heated in anticipation of a shape change. Only heating or cooling the necessary portions above the glass transition temperature protects the remaining portions from exposure to damage.

Optionally, the method comprises controlling an actuator to actuate a shape change of the aircraft morphable aerodynamic surface structure. The temperature management system is usable to soften the elastomeric material to therefore facilitate operation of the actuator to cause the shape change.

A third aspect of the present invention provides a non-transitory storage medium storing machine-readable instructions that, when executed by a processor of a controller for controlling an aircraft morphable aerodynamic surface structure, cause the processor to perform the method of the second aspect.

A fourth aspect of the present invention provides an aircraft comprising an aircraft morphable aerodynamic surface according to the first aspect or a non-transitory storage medium according to the third aspect.

Optional features of aspects of the present invention may be equally applied to other aspects of the present invention, where appropriate.

### BRIEF DESCRIPTION OF THE DRAWINGS

Embodiments of the invention will now be described, by way of example only, with reference to the accompanying drawings, in which:

FIG. 1 shows a schematic view of an aircraft;

FIGS. 2a and 2b show schematic partial cross sections of a wing of the aircraft of FIG. 1 with a morphable aerodynamic surface structure at its surface, in FIG. 2a with a moveable part of the wing at a first position relative to a fixed part of the wing and in FIG. 2b with the moveable part of the wing at a second position relative to the fixed part of the wing;

FIG. 3 shows a schematic representation of the operational structure of the morphable aerodynamic surface structure;

FIGS. 4a to 4e show sections from some example elastomeric materials of embodiments of the morphable aerodynamic surface structure of the invention;

FIG. 5 shows a schematic representation of temperature ranges of operation of the aircraft and the mechanical properties of an elastomer at those temperatures;

FIG. 6 shows a flow chart of a method of controlling an aircraft morphable aerodynamic surface structure according to an embodiment of the invention; and

FIG. 7 shows a flow chart of a method of controlling an aircraft morphable aerodynamic surface structure according to another embodiment of the invention.

### DETAILED DESCRIPTION

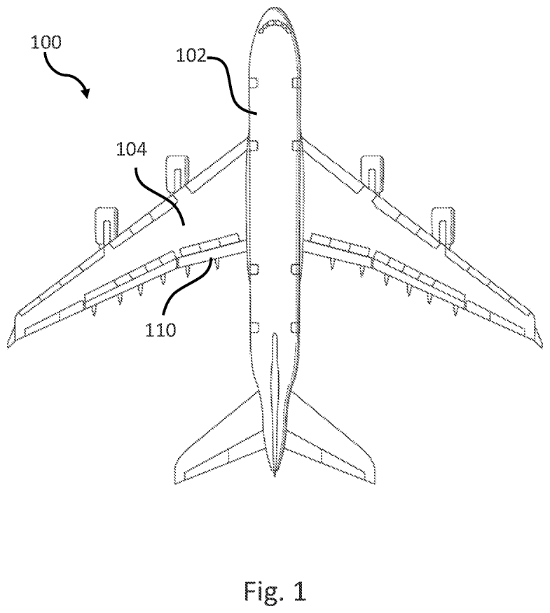

An example aircraft 100 is shown in FIG. 1. The aircraft 100 comprises a fuselage 102 and a pair of wings 104 extending from the fuselage.

In this described embodiment, each of the wings 104 comprises a morphable aerodynamic surface structure 110. A different shape of the wings may be advantageous during take-off and/or landing of the aircraft than the optimal shape at cruising altitude. The morphable aerodynamic surface structures 110 of the wings 104, i.e., aerodynamic surface structures that are able to change shape, are provided to facilitate a shape change of the wings 104 in order to give the wings a more optimum shape for given circumstances.

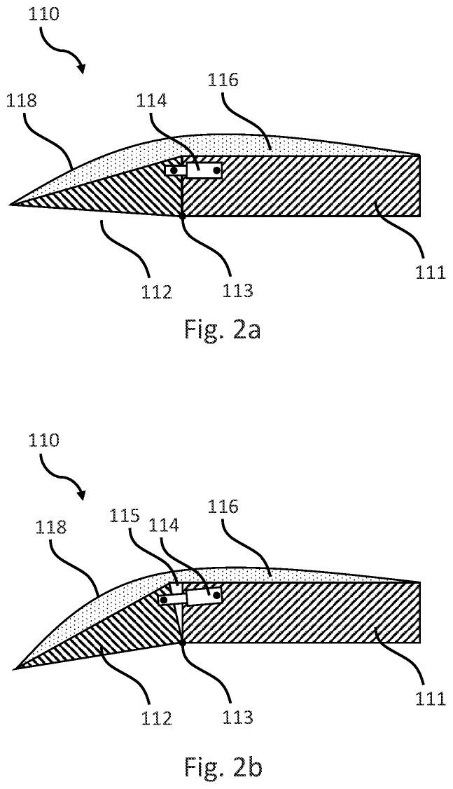

The morphable aerodynamic surface structures 110 in this embodiment are located at, and define, surfaces of the respective wings 104. This is schematically shown in FIGS. 2a and 2b by way of example, in schematic partial cross-sectional views of one of the wings 104. The morphable aerodynamic surface structure 110 comprises a fixed portion 111 and a moveable portion 112. The moveable portion 112 is movably connected to the fixed portion 111, in this example by way of a hinge 113 but other connection mechanisms are used in other examples. In this example, the moveable portion 112 is a flap, but the moveable portion 112 could be any other flight control surface or any other structure on the wing 104 in other examples. Actuators (only one 114 of which is shown in FIG. 2) are each pivotally connected to each of the fixed and moveable portions 111, 112 and actuatable to move the moveable portion 112 relative to the fixed portion 111 to thereby actuate a shape change of the morphable aerodynamic surface structure 110 and, thus, the wing 104. In this example, extension of the actuator 114 causes extension and dropping of the flap 112 (as shown in FIG. 2b), and retraction of the actuator 114 causes retraction of the flap 112 (as shown in FIG. 2a). In other examples, the actuators could, for example, instead be of the type used in soft robotics to enable small scale manipulation of surface profiles of the surface structures 110.

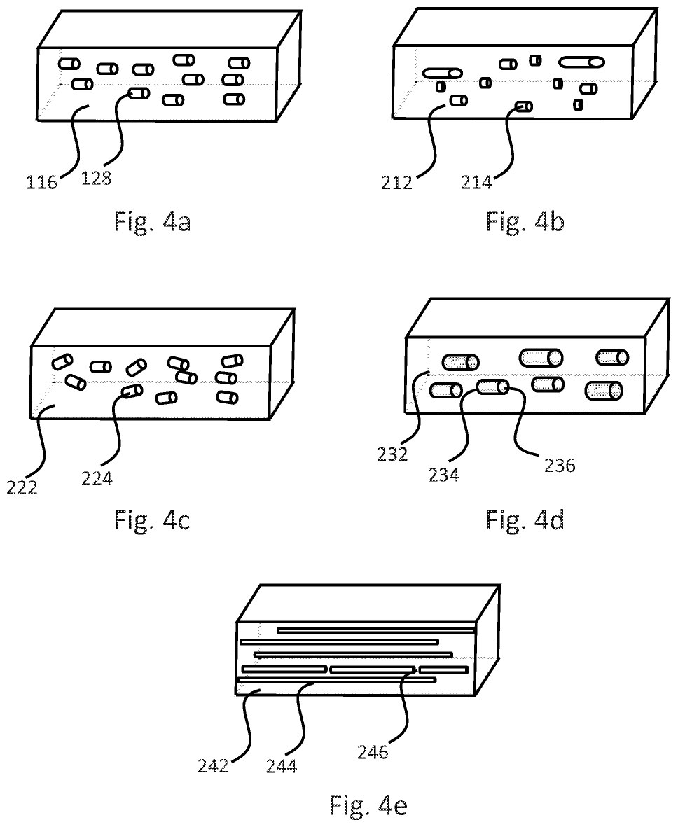

The morphable aerodynamic surface structure 110 also comprises a skin comprising an elastomeric material 116, which has a glass transition temperature Tg. The elastomeric material 116 contains carbon nanotubes (not shown in FIG. 2, but discussed below with reference to FIG. 4). Without the skin, when the moveable part 112 is at the position shown in FIG. 2b, there would otherwise be a gap 115 in an aerodynamic surface defined by the fixed and moveable parts 111, 112. The elastomeric material 116 of the skin covers this gap 115 and defines an aerodynamic surface 118 of the morphable aerodynamic surface structure 110 and the wing 104. As can be seen by comparison of FIGS. 2a and 2b, the elastomeric material 116 changes shape as the moveable part 112 moves relative to the fixed part 111, yet always defines a smooth surface 118.

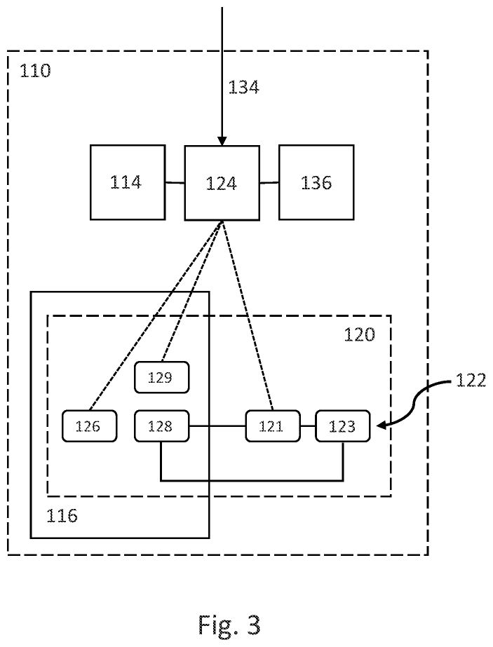

Another schematic view of the morphable aerodynamic surface structure 110 is shown in FIG. 3. The structure 110 comprises a temperature management system 120 and a controller 124, in addition to the elastomeric material 116 discussed above. The temperature management system 120 comprises a heating system 122, which is for heating the elastomeric material 116 to facilitate a shape change of the structure 110 and for improving resistance to bird strikes, and a cooling system 129, which is for cooling the elastomeric material 116 to increase its hardness and therefore improve its resistance to e.g., sand erosion.

The heating system 122 comprises the carbon nanotubes 128 that are contained in the elastomeric material 116. In other examples, the heating system 122 comprises heatable material other than carbon nanotubes, such as other electrically-conductive nanoparticles or particles dispersed or arranged in or on the elastomeric material 116, or indeed any form of electrically conductive material arranged in or on the elastomeric material 116. The heating system 122 also comprises an electrical power supply 123 and a switch 121. The electrical power supply 123, the switch 121 and the carbon nanotubes 128 are electrically arranged so that closing of the switch 121 causes an electric current to flow from the electrical power supply 123 and thus resistive (Joule) heating of the carbon nanotubes 128 to take place. In FIG. 3, the carbon nanotubes 128 are shown as being comprised in an electrical circuit with the electrical power supply 123 and the switch 121. While this is possible in some examples, in others the carbon nanotubes 128 are separate from the electrical circuit and the electrical circuit instead comprises a coil for generating a magnetic field that is configured to pass through the carbon nanotubes 128 to generate eddy currents in the carbon nanotubes 128 to heat the carbon nanotubes 128 by resistance (Joule) heating.

The cooling system 129 comprises a refrigeration system that has refrigerant in fluid flow channels that are in thermal contact with the elastomeric material 116. The controller 124 is operatively connected to the cooling system 129 and is configured to control the cooling system 129 as required.

The temperature management system 120 also comprises a temperature sensor 126, which is embedded in the elastomeric material 116. In other examples, the temperature sensor 126 is arranged on or in close proximity to the elastomeric material 116. In any event, the temperature sensor 126 is configured to sense and monitor a temperature of the elastomeric material 116.

The controller 124 is communicatively connected to the temperature sensor 126 so as to receive an output from the temperature sensor 126, thereby to monitor the temperature of the elastomeric material 116 and control the temperature management system 120 on the basis of the output from the temperature sensor 126. A non-transitory storage medium 136 storing machine-readable instructions is communicatively connected to the controller 124 and provided to enable the operation of the controller 124. That is, the instructions, when executed by a processor of the controller 124, cause the processor to perform the method of an embodiment of the present invention, examples of which will be discussed below. The non-transitory storage medium 136 also stores historical information about the characteristics of the aircraft morphable aerodynamic surface structure 110, including a temperature of the elastomeric material 116, the position of the actuators 114, and air pressure at a surface of the structure 110, for commands given to the temperature management system 120 and the actuators 114 in a range of given previous circumstances, including a range of different ambient temperatures. This historical information is used by the controller 124, when commanded to control the structure 110, to refine the commands it gives to the temperature management system 120 and the actuators 114 so that they operate to provide an improved result (compared to if the historical information were not used).

The controller 124 is configured to, on the basis of a command 134 received at the controller 124, such as for example a command to prepare the aircraft for landing generated manually by the crew or in response to a change in altitude, operate the heating system 122 to heat the elastomeric material 116 and thus to facilitate a shape change of the morphable aerodynamic surface structure 110. More specifically, the controller 124 is operatively connected to the actuators 114 and is configured to selectively operate the heating system 122 to heat the elastomeric material 116 to thereby facilitate the shape change, as driven by the actuators 114.

FIG. 3 shows one electrical circuit comprising the heatable material 128, which is arranged to heat a specific portion of the elastomeric material 116. This portion is a region that changes shape on operation of the actuator 114. In other examples, the heating system 122 is configured to heat plural respective portions of the elastomeric material 116 independently of each other, and the controller 124 is configured to control the heating system 112 to heat the respective portions of the elastomeric material 116 independently of each other. In other words, in some such examples, the heating system 122 comprises plural such electrical circuits (at least one circuit per portion of the elastomeric material 116) and the controller 124 is configured to operate the respective switches 121 independently of each other, depending on which of the portions of the elastomeric material 116 are to be heated, in order to cause heating of the respective heatable materials 128 in the respective circuits. A first group of the plural portions of elastomeric material 116 have respective shapes that are changeable on operation of the illustrated actuator 114, and a differing number of the first group of the plural portions change shape depending on the extent of operation or throw of the same actuator 114. That is, all of the plural portions of elastomeric material 116 (i.e., including those relatively far from the actuator 114) in the first group change shape when the actuator 114 performs a relatively large movement, and only some of the plural portions of elastomeric material 116 (i.e., excluding those relatively far from the actuator 114) in the first group change shape when the actuator 114 performs a relatively small movement. Moreover, in some such examples, the structure 110 comprises plural actuators 114 and respective groups of the plural portions of elastomeric material 116 have respective shapes that are changeable on operation of the respective actuators 114. That is, the actuators 114 are actuatable to change the shape of respective different portions of the elastomeric material 116, such as different portions of one of the wings 104. In some such embodiments, the heating system 122 also comprises plural temperature sensors 126, each of which is to monitor the temperatures of the respective portions of elastomeric material 116 and inform the controller 124 of the temperatures so that the controller 124 is able to determine whether or not heating of the respective portions of elastomeric material 116 is to be performed.

FIGS. 4a-e show some examples of the elastomeric material 116 containing carbon nanotubes 128, as are employed in different respective embodiments. Each of these is represented as a section of the elastomeric material 116 to show what is contained therein, and is not to scale with the whole of the elastomeric material 116 or whole of the aircraft morphable aerodynamic surface structure 110.

FIG. 4a shows a schematic section of the elastomeric material 116 of FIGS. 2a and 2b. The elastomeric material 116 constitutes a composite matrix, i.e., a main constituent which holds one or more embedded additives in a composite material, wherein the elastomeric material 116 comprises unidirectional carbon nanotubes 128 as an additive. Carbon nanotubes 128 are included in this embodiment, and the further embodiments of FIGS. 4b-4e, to serve as conductive pathways through the otherwise highly electrically resistive elastomer. This facilitates the heating of the elastomeric material 116 by permitting a passage of an electric current. When an electric current is passed through an electrical conductor, such as the carbon nanotubes 128, heat is generated within the electrical conductor due to the interactions of electrons, moving at high speeds and volumes through the electrical conductor when the electric current is applied, with the structure of the conductor resulting in power loss experienced as heat. Carbon nanotubes 128 were chosen as an additive in the elastomeric material 116 for their relatively high electrical conductivity. High conductivity is desired to increase the current I experienced by the electrical conductor, which increases the total heat Q dissipated in a proportional relationship of Q∝I². The carbon nanotubes 128 are provided as part of the heating system 122 as controlled by the controller 124, as described above with respect to FIG. 3. The high electrical conductivity of the carbon nanotubes 128 also permits suitable conductive pathways to be formed even at relatively small ratios of additive to matrix of about 2%. Maintaining a relatively low volume of additives in a composite serves to, for example, preserve some of the mechanical properties of the matrix, such as the elastic modulus and the shear modulus, permitting their desirable visco-elastic behaviour to be exploited in shape changing of the elastomeric material 116 in this case. Further embodiments comprising some possible forms of carbon nanotubes or their orientations are shown in FIGS. 4b-4e.

FIG. 4b shows a section of an aircraft morphable aerodynamic surface structure comprising a matrix of elastomeric material 212 and carbon nanotubes 214 of non-uniform length.

FIG. 4c shows a section of an aircraft morphable aerodynamic surface structure comprising a matrix of elastomeric material 222 and carbon nanotubes 224 of non-uniform orientation.

FIG. 4d shows a section of an aircraft morphable aerodynamic surface structure comprising a matrix of elastomeric material 232 and carbon nanotubes 234 of a multi-wall type. The carbon nanotubes 234 in this embodiment comprise a plurality of concentric nanotubes 236. Such carbon nanotubes 236 are called multi-wall carbon nanotubes and arise when certain processes are used in synthesis of the carbon nanotubes 234, as the carbon nanotubes grow concentrically within each other. Multi-wall carbon nanotubes 236 may have different properties from single-walled carbon nanotubes, which only consist of a singular tube, such as for example electrical conductivity or mechanical properties. In other embodiments, the carbon nanotubes may contain other nano-scale carbon or non-carbon particles instead of, or in addition to, concentric tubes, such as fullerenes, which are spherical carbon nanoparticle cages, metallic or non-metallic ions or compounds, or organic compounds.

FIG. 4e shows a section of an aircraft morphable aerodynamic surface structure comprising a matrix of elastomeric material 242 and carbon nanotubes 244 with lengths of the order of the component sections. Some of these carbon nanotubes have breaks such as that indicated at point 246. The breaks may occur prior to or in service, and this is to be accounted for in deciding the ratio of carbon nanotubes 244 in the elastomeric material 242 in order to achieve desired properties, such as electrical conductivity.

The length, thickness and other properties of the carbon nanotubes, such as their single-wall or multi-wall configuration, or presence of other additives and the uniformity of such properties, is dependent on the synthesis method and selection of the carbon nanotubes. Some example methods of preparing carbon nanotubes are Chemical Vapour Deposition (CVD) and arc discharge. The orientation of the carbon nanotubes within the elastomeric material matrix is a function of a process by which the carbon nanotubes are introduced into the elastomeric material 116 and any other processing they undergo.

Further embodiments of the elastomeric material 116 and the heating system 122 are envisaged, which are not shown. For example, laminate structures with several principal directions of the carbon nanotubes, or embodiments where the carbon nanotubes are replaced by other conductive filler material, are envisaged. In some examples, the heatable material of the heating system 122 comprises one or more electrically conductive wires or tracks that are embedded in, or otherwise located within, the elastomeric material 116 and electrically connected in the electrical circuit discussed above.

The heatable material of the heating system 122 in other embodiments is located on an outside surface of the elastomeric material 116 or in close proximity to the elastomeric material 116, in the form of one or more wires, tracks, rods, plates or coatings, for example.

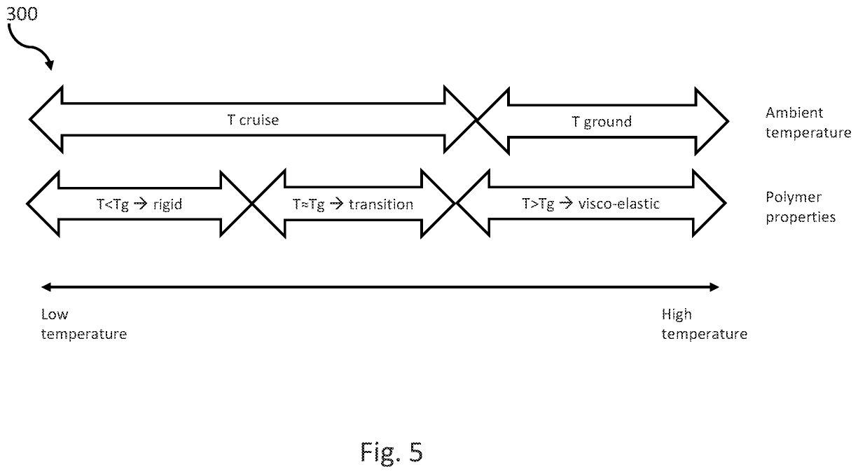

FIG. 5 shows a schematic diagram of the temperatures of the environment of the aircraft 100 at each stage of operation of the aircraft 100, and in parallel the approximate temperature ranges for the glass transition temperature below which the elastomeric material 116 will have glassy mechanical properties and above which the elastomeric material 116 will have visco-elastic properties.

The glass transition temperature of an elastomer depends on both external factors and the material selection. For example, a glass transition temperature may be influenced by stress applied to the elastomer. It is important that this is taken into account when evaluating the temperature of the material 116 and whether or not the material 116 requires heating in order to undergo a shape change. Glass transition temperature is in practice often a range, of the order of 1-10° C., as the transition occurs gradually from the glassy state to the viscoelastic state. The controller 124 is to be configured with information, via the non-transitory storage medium 136 and via the output of the temperature sensor 126, to accurately determine what the glass transition temperature is and what the temperature of the elastomeric material 116 is in relation to the glass transition temperature or temperature range.

The glass transition temperature of common elastomers, such as polyurethane rubber, are above the typical temperature at cruising altitude of an aircraft. In other words, without intervention, the elastomer would be glassy. On the ground, and particularly in for example desert environments, temperatures are higher and generally above the glass transition temperature of common elastomers. In other words, the elastomer would be rubbery.

Selectively operating the heating system 122 when needed to raise the temperature of the elastomeric material 116 to bring it into the visco-elastic (rubbery) regime, according to some embodiments of the present invention, will facilitate shape change of the elastomeric material 116 and the structure 110 as a whole, especially at cruise altitude of the aircraft 100 or when the aircraft 100 is in other relatively cold environments.

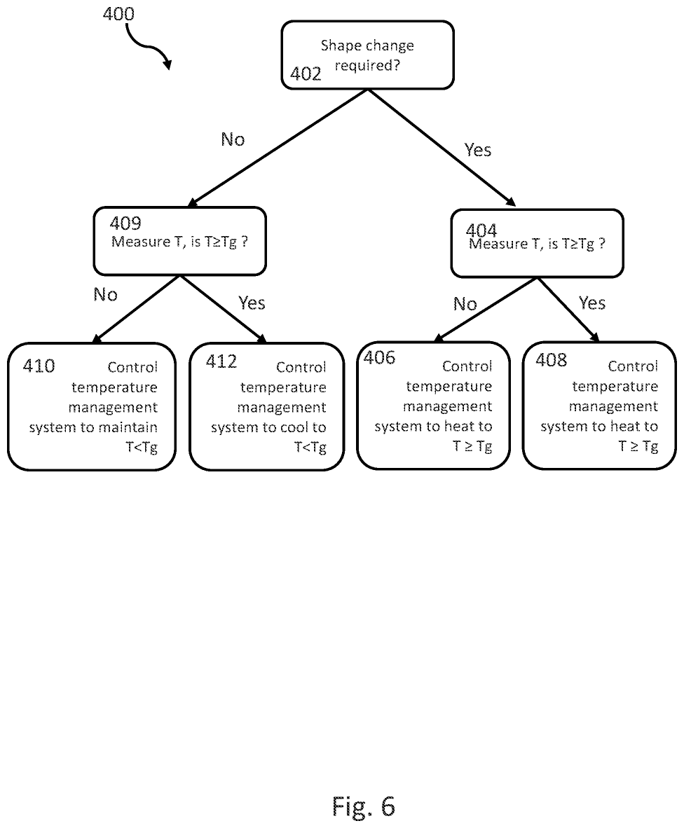

FIG. 6 shows a flow chart of a method 400 of controlling a change in shape of an aircraft morphable aerodynamic surface structure 110 according to an embodiment of the invention. The method 400 comprises the controller 124 determining 402 whether or not a shape change of the structure 110 is required. This decision is on the basis of the command 134 to operate the actuators 114 being received by the controller 124. If a shape change is not required, i.e., the command 134 is not received, then the controller 124 does not cause operation of the actuators 114. The controller 124 determined 409 whether the temperature T of the elastomeric material is above the glass transition temperature Tg. If the answer to determination 409 is ‘no’ then the controller 124 controls 410 the temperature management system 120 maintain the temperature T of the elastomeric material 116 below the glass transition temperature Tg. If the answer to the determination 409 is ‘yes’ then the controller 124 controls 412 the temperature management system 120 to cool the elastomeric material 116. If a shape change is required, i.e., the controller 124 has received the command 134, then the controller 124 determines 404 whether or not the existing temperature T of the elastomeric material 116 is at or above the glass transition temperature Tg based on the temperature monitoring performed using the temperature probe 126. If the temperature T of the elastomeric material 116 is measured to be at or above Tg, then the controller 124 controls 408 the temperature management 120 system merely to maintain the temperature above Tg. If the temperature T is below Tg, the controller 124 instead controls 406 the thermal management system to heat the elastomeric material 116 above Tg. In other words, if the temperature T is to be increased to above Tg, the temperature management system 120 is operated at a greater capacity, for example by passing a higher electrical current through the heatable material, than if the temperature T needs only be maintained. Regardless as to which of blocks 406 and 408 is performed, the controller 124 also controls the actuators 114 to actuate the required shape change.

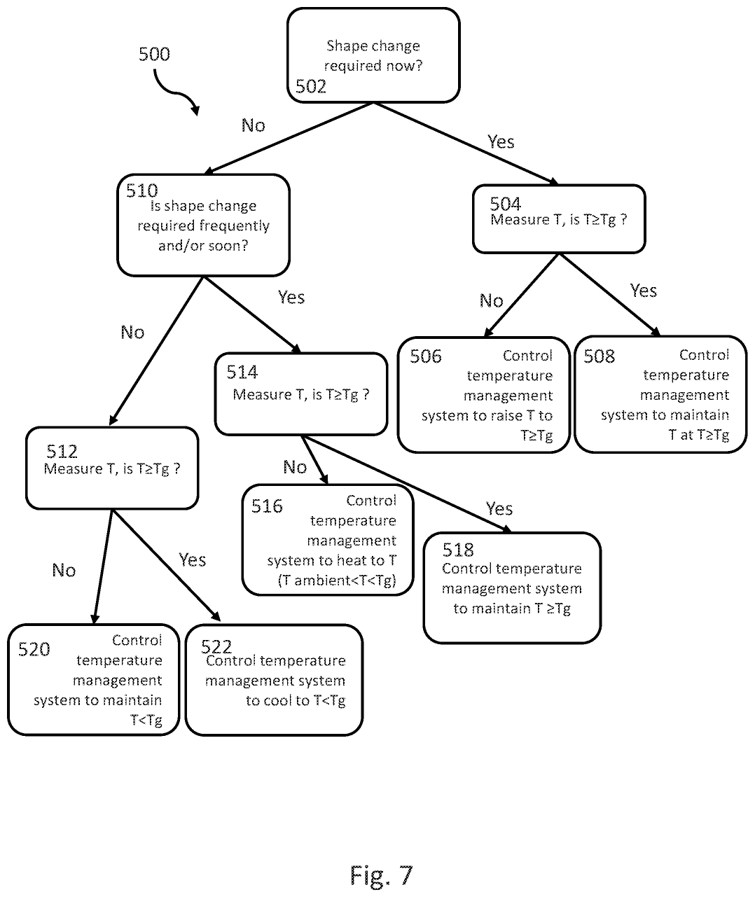

FIG. 7 shows a flow chart of a method 500 of controlling a change in shape of an aircraft morphable aerodynamic surface structure 110 according to another embodiment of the invention. In this embodiment, the controller 124 determines 502 whether a shape change is required now, for example because the aircraft 100 is in or entering a cold environment and movement of the actuators 114 is, or will be, needed. If the answer to this determination 502 is “yes”, then blocks 504, 506 and 508 are the same as blocks 404, 406 and 408 discussed above with reference to FIG. 4, and regardless as to which of blocks 506 and 508 is performed, the controller 124 also controls the actuators 114 to actuate the required shape change.

On the other hand, if the answer to the determination at block 502 is “no”, then the controller 124 determines 510 if a shape change will be likely required imminently, according to preprogramed criteria. This new consideration 510 permits a pre-emptive heating of the elastomeric material 116 to facilitate further rapid heating of any parts of the elastomeric material 116 which might require a shape change on a frequent basis or for which shape change will be required imminently, such as for example, in anticipation of a landing or take-off procedure, an in-air manoeuvre such as change of direction or altitude, or a predicted imminent bird strike. If the answer to the determination 510 is “no”, then the controller 124 determines 512 whether or not the existing temperature T of the elastomeric material 116 is at or above the glass transition temperature Tg based on the temperature monitoring performed using the temperature probe 126. If the answer to the determination 512 is “no” then the controller 124 controls 520 the temperature management system to maintain the temperature T of the elastomeric material 116 below Tg. This may comprise actively cooling of the elastomeric material 116 by controlling the cooling system 129, or not heating nor cooling the elastomeric material, depending on the ambient temperature. If the ambient temperature is below the temperature T of the elastomeric material 116 then cooling is not required as the temperature T will decrease passively and is already below Tg. Alternatively, cooling may be required even if the temperature T of the elastomeric material is above ambient temperature, if for example the difference between ambient temperature and the temperature T of the elastomeric material 116 is too small and passive cooling would not be sufficiently rapid. Threshold (minimal) difference values may be programmed at which active cooling by controlling the cooling system 129 is required, even if the ambient temperature is below the temperature T of the elastomeric material 116, for when the passive cooling would be insufficient. Maintaining temperature T of the elastomeric material 116 below Tg if no shape change is imminently required facilitates prevention of damage by, for example, water or sand erosion, and of fluttering of the elastomeric material 116 which is detrimental to aerodynamic properties of a surface. If the answer to the determination 512 is “yes” then the controller 124 controls 522 the temperature management system 120 to cause cooling of the elastomeric material 116. The cooling of the elastomeric material 116 may be by either controlling the cooling system 129 or by exposure to ambient temperature, if the ambient temperature is lower than the temperature T of the elastomeric material. A consideration may be included of whether rapid cooling (i.e. through the operation of the cooling system 129) is required, for example in anticipation of harsh conditions, such as for example sand or water erosion. On the other hand, if the answer to the determination 510 is “yes”, then the controller 124 determines 514 whether or not the existing temperature T of the elastomeric material 116 is at or above the glass transition temperature Tg based on the temperature monitoring performed using the temperature probe 126. If the temperature T of the elastomeric material 116 is at or above Tg, then the controller 124 controls 518 the temperature management system to maintain the temperature of the elastomeric material 116 above the glass transition temperature Tg. Alternatively, if the temperature T of the elastomeric material 116 is below Tg, then the controller 124 controls 516 the thermal management system 120 to raise the temperature of the elastomeric material 116 to a temperature that is below Tg but above an ambient temperature 516 of the elastomeric material 116. Accordingly, once the shape change is subsequently required and the controller 124 controls the actuators 114 to cause the shape change, raising the temperature above Tg (block 506) will be more rapidly achieved.

A set criteria are provided as thresholds for decisions of the controller 124 by programming of the controller, such as by way of providing instructions stored on the non-transitory storage medium 136. These criteria may be set, for example, to cause heating, of any part of the elastomeric material 116 which experienced shape change on average more than 100 times per flight, to below Tg in order that the elastomeric material 116 is “on stand by” for heating to above Tg. The pre-emptive heating is also triggerable by a manual input from a member of a flight crew, for example in anticipation of landing. Another example may be that any part which is to be morphed in the next 15 seconds is considered to require shape change “now” in accordance with block 502.

It will thus be appreciated that each of blocks 402, 510 and 514 constitutes the controller 124 determining whether to control the heating system 122 to heat the elastomeric material 116.

It should be appreciated that each of the methods 400 and 500 of respective FIGS. 6 and 7 is performed by a controller 124 that is for controlling the temperature of different respective portions of the elastomeric material 116 of the morphable aerodynamic surface structure 110. Although the discussions above concern the controller's 124 operation of actuators 114 and controlling the temperature of an associated portion of the elastomeric material 116, the controller 124 is also for independently operating other actuators 114 and controlling the temperature of other associated portions of the elastomeric material 116. Each portion of the elastomeric material 116 has an associated temperature sensor 126 that informs the controller 124 of the temperature of the portion of the elastomeric material 116. In other examples, separate controllers 124 are provided for controlling the temperature of respective portions of the elastomeric material 116.

It will be appreciated that other conditions may be factored into the method of controlling a change in shape of an aircraft aerodynamic surface structure in other envisaged embodiments of the invention. In an envisaged embodiment, the controller takes into account a target temperature above Tg to which to heat the elastomeric material during shape change so that unnecessary heating does not occur. In another envisaged embodiment, the controller is configured to determine whether the elastomeric material is above or below the glass transition temperature Tg by measuring factors other than the temperature such as for example a measurement of stress-strain characteristics.

It is to be noted that the term “or” as used herein is to be interpreted to mean “and/or”, unless expressly stated otherwise.

1. An aircraft morphable aerodynamic surface structure, comprising:
an elastomeric material having a glass transition temperature, and
a controller configured to control a temperature management system that is configured to change a temperature of the elastomeric material,
wherein the controller configured is configured to control the temperature management system based on a command received at the controller.

2. The aircraft morphable aerodynamic surface structure according to claim 1 further, comprising the temperature management system.

3. The aircraft morphable aerodynamic surface structure according to claim 2, wherein the temperature management system comprises:
a heating system for heating the elastomeric material, and/or
a cooling system for cooling the elastomeric material.

4. The aircraft morphable aerodynamic surface structure according to claim 3, wherein the heating system comprises a heatable material and is configured to cause heating of the heatable material to cause heat to be transferred from the heatable material to the elastomeric material.

5. The aircraft morphable aerodynamic surface structure according to claim 4, wherein the heatable material is located within the elastomeric material.

6. The aircraft morphable aerodynamic surface structure according to claim 4, wherein the heatable material is electrically conductive and the heating system is configured to pass an electric current through the heatable material to resistively heat the heatable material.

7. The aircraft morphable aerodynamic surface structure according to claim 4, wherein the heatable material comprises particles dispersed in the elastomeric material.

8. The aircraft morphable aerodynamic surface structure according to claim 7, wherein the particles comprise nanoparticles.

9. The aircraft morphable aerodynamic surface structure according to claim 8, wherein the nanoparticles are carbon nanotubes.

10. The aircraft morphable aerodynamic surface structure according to claim 1, comprising an actuator for actuating a shape change of the aircraft morphable aerodynamic surface structure.

11. The aircraft morphable aerodynamic surface structure according to claim 10, wherein the actuator is for actuating the shape change of the aircraft morphable aerodynamic surface structure under control of the controller.

12. The aircraft morphable aerodynamic surface structure according to claim 1, further comprising a temperature sensor for monitoring a temperature of the elastomeric material, wherein the controller is configured to control the temperature management system on the basis of an output of the temperature sensor.

13. The aircraft morphable aerodynamic surface structure according to claim 1, wherein the temperature management system is for changing a temperature of respective portions of the elastomeric material independently of each other, and wherein the controller is configured to control the temperature management system to change the temperature of the respective portions of the elastomeric material independently of each other.

14. A method of controlling an aircraft morphable aerodynamic surface structure comprising an elastomeric material having a glass transition temperature, the method comprising:
receiving a command; and
based on the command, controlling a temperature management system,
wherein the temperature management system is configured to change a temperature of the elastomeric material.

15. The method of claim 14, wherein the controlling the temperature management system comprises controlling a heating system of the temperature management system to heat the elastomeric material above an ambient temperature of the elastomeric material.

16. The method according to claim 14, wherein the controlling the temperature management system comprises controlling a heating system of the temperature management system to heat the elastomeric material to a temperature below the glass transition temperature.

17. The method according to claim 14, wherein the controlling the temperature management system comprises controlling a heating system of the temperature management system to heat the elastomeric material to, or to above, the glass transition temperature.

18. The method according to claim 14, wherein the controlling the temperature management system comprises controlling a heating system of the temperature management system to not heat the elastomeric material.

19. The method according to claim 14, wherein the controlling the temperature management system comprises controlling a cooling system of the temperature management system to cool the elastomeric material.

20. The method according to claim 14, further comprising monitoring a temperature of the elastomeric material, wherein the controlling the temperature management system is on the basis of the monitoring.

21. The method according to claim 14, further comprising determining whether to control the temperature management system, wherein the controlling the temperature management system is on the basis of the determining.

22. The method according to claim 14, wherein the temperature management system is for changing a temperature of respective portions of the elastomeric material independently of each other, and wherein the controlling the temperature management system comprises controlling the temperature management system to change the temperature of only one or a subset of the respective portions of the elastomeric material.

23. The method according to claim 14, further comprising controlling an actuator to actuate a shape change of the aircraft morphable aerodynamic surface structure.

24. A non-transitory storage medium storing machine-readable instructions that, when executed by a processor of a controller for controlling an aircraft morphable aerodynamic surface structure, cause the processor to perform the method of claim 14.

25. An aircraft comprising the aircraft morphable aerodynamic surface structure according to claim 1.
